(19) United States
(12) Patent Application Publication
(10) Pub. No.: US 2010/0260972 A1
(43) Pub. Date: Oct. 14, 2010

(54) Protective Member and Protective Body Using the Same

(75) Inventors: Takehiro Oda, Kirishima-shi (JP); Teppei Kayama, Kirishima-shi (JP); Masahito Nakanishi, Kirishima-shi (JP)

Correspondence Address: Hogan Lovells US LLP, 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/669,941

(22) PCT Filed: Mar. 28, 2008
(86) PCT No.: PCT/JP2008/056193

§ 371 Date: Jun. 21, 2010

(30) Foreign Application Priority Data
Jul. 30, 2007 (JP) 2007-196942

(51) Int. Cl. C04B 35/565; B32B 18/00; C04B 35/52

(52) U.S. Cl. 428/156; 428/446; 501/88; 501/90

(57) ABSTRACT

This invention provides a protective member comprising a ceramic body comprising a plurality of first phases (2) composed mainly of silicon carbide and a plurality of second phases (3) having a composition different from the composition of the first phase (2) and containing at least boron, silicon and carbon. A part of the second phase is present in the first phase as a whole, and at least a part of the remaining part of the second phase is present between a plurality of the first phases.

### TECHNICAL FIELD

The present invention relates to a lightweight protective member having high thermal shock resistance, and a protective body using the same. In particular, the present invention relates to a protective member for suppressing the penetration of flying objects such as a bullet and a shell, or a sharp edged tool to protect human bodies, vehicles, vessels and aircraft or the like, protective tools such as a bulletproof vest, a stab-proof vest, a stab-proof shield, a bag with a bulletproof function and a bulletproof helmet which use the same, and protective bodies such as a bulletproof plate.

### BACKGROUND ART

Recently, the demand for protective members having excellent property has been increasing. Particularly, lightweight protective members capable of bearing large impact compression received from the bullet and the shell or the like have been required.

For example, Patent Document 1 proposes a bulletproof attachment for a helmet including a cover for covering the outside of the helmet and an impact-resistant reinforcing member attached to positions corresponding to the fore and back head portions of the helmet in the cover. The impact-resistant reinforcing member is mainly made of a ceramic. The main component of the ceramic is constituted by at least one selected from silicon carbide, boron carbide, silicon nitride and alumina.

Patent Document 2 proposes a ceramic tile having a polygonal plane shape wherein an apex part has a thickness thicker than that of a center part. This ceramic tile, which is made of alumina, silicon nitride, silicon carbide, zirconia or boron carbide, is used for a bulletproof plate, a bulletproof vest or a stab-proof vest.

Patent Document 1: Japanese Patent Application Laid-Open No. 2002-294512

Patent Document 2: Japanese Patent Application Laid-Open No. 2002-326861

### DISCLOSURE OF THE INVENTION

### Problem to be Solved by the Invention

However, presently, there have been desired a protective member having high thermal conductance and having higher thermal shock resistance, and a protective body using the same.

### Means for Solving the Problems

A protective member of the present invention is characterized by having a ceramic body having a plurality of first phases including silicon carbide as a main component and a plurality of second phases having a composition different from that of the first phase and including at least boron, silicon and carbon.

The protective body of the present invention is characterized by having a base and at least the protective member provided on the base.

### EFFECT OF THE INVENTION

The protective member of the present invention suppresses a local temperature rise generated by impact since, particularly, the presence of the first phase enhances thermal conductance. As a result, the protective member can minimize reduction in hardness and elastic modulus, and hardly damages protecting performance against a flying object. Particularly, the presence of the second phase enhances thermal shock resistance. This can bear a local sudden temperature change generated by the impact, hardly generates microcracks, and can enhance the protecting performance against the flying object. Furthermore, these effects are remarkably caused by enhancing the density of the protective member. Thereby, closed pores are decreased, and the thermal conductance is further enhanced to further suppress the local temperature rise.

As described above, the protective body of the present invention, which includes the base and the plurality of ceramic bodies provided on the base and has high protecting performance, can suppress the penetration of the flying object with high probability.

### BRIEF DESCRIPTION OF THE DRAWINGS

FIG. 1 illustrates an embodiment of a protective member according to the present invention, and is a plan view schematically showing the crystal structure of a silicon carbide sintered body used for a ceramic body constituting the protective member;

FIG. 2 illustrates another embodiment of a protective member according to the present invention, and is a plan view schematically showing the crystal structure of a silicon carbide sintered body used for a ceramic body constituting the protective member;

FIG. 3 is a plan view illustrating the aspect ratio of a crystal phase;

FIG. 4 is a perspective view showing an embodiment of a ceramic body constituting a protective member according to the present invention;

FIG. 5 is a perspective view showing another embodiment of a ceramic body constituting a protective member according to the present invention;

FIG. 6A is a perspective view showing a part of an embodiment of a protective body according to the present invention; and

FIG. 6B is a plan view showing an embodiment of a protective body according to the present invention.

### BEST MODE FOR CARRYING OUT THE INVENTION

Hereinafter, best mode for carrying out the present invention will be described in detail with reference to the drawings schematically shown.

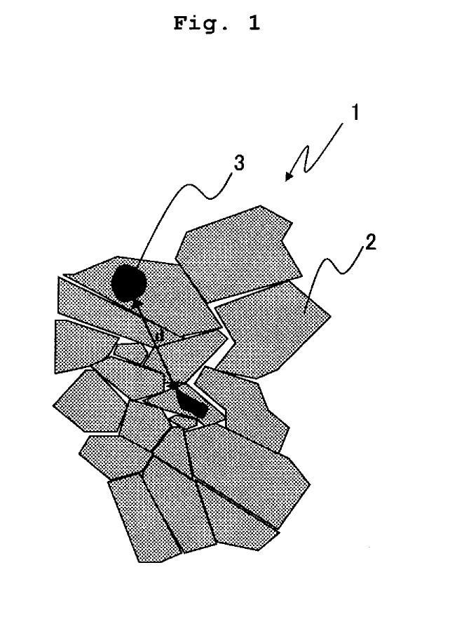

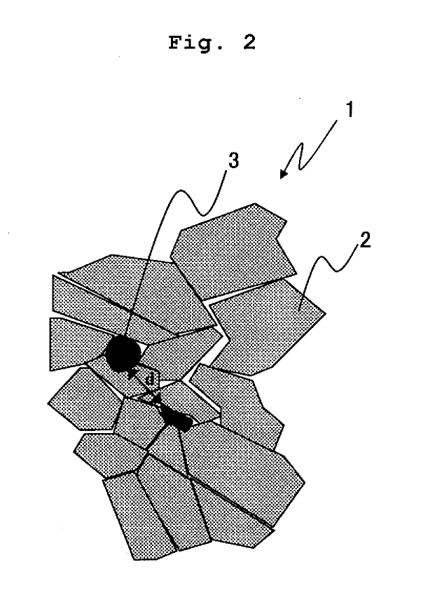

As shown in FIGS. 1 and 2, a protective member of this embodiment includes a silicon carbide ceramic body 1 including a plurality of first phases including silicon carbide as amain component and a plurality of second phases having a composition different from that of the first phase and including at least boron, silicon and carbon. Herein, the term “main component” means a component occupying 70% by mass or more of components constituting the ceramic body 1.

As shown in FIG. 1, in the ceramic body 1 of the protective member of the embodiment, the whole of a second phase 3 may be present in a first phase 2. That is, a part of the plurality of second phases 3 may be present in the first phase 2 as a whole. In this case, when, in a predetermined cross section region (for example, a square region of 14 μm×16 μm), a ratio of “the total area of the second phases 3 which are present in the first phase 2/the total area of the second phases 3 which are present in the predetermined cross section region” is not less than 5% and less than 50%, the difference between the thermal expansion coefficient of the first phase 2 and the thermal expansion coefficient of the second phase 3 causes the generation of residual stress which is moderate for the protective member. This residual stress brings about a state where compressive stress is applied to the grain boundary between the first phases 2, and the land of flying objects such as a bullet and a shell causes the generation of cracks in the protective member. However, the tips of the cracks are comparatively easily caught by the grain boundary or are dispersed, and thereby the development of the cracks can be suppressed.

As shown in FIG. 2, in the ceramic body 1, the second phase 3 may be present between the plurality of first phases 2. That is, at least a part of the remaining part of the plurality of second phases 3 may be present between the plurality of first phases 2. In this case, when, in the predetermined cross section region, a ratio of “the total area of the second phases 3 which are present between the plurality of first phases 2/the total area of the second phases 3 which are present in the predetermined cross section region” is not less than 50% and less than 95%, phonons which are heat conductive carriers are easy to move as compared with a case where a ratio of “the total area of the second phases 3 which are present in the first phase 2/the total area of the second phases 3 which are present in the predetermined cross section region” is less than 50%. This exhibits high thermal conductance of a silicon carbide crystal sufficiently, and suppresses a local temperature rise generated by impact added from the flying objects such as the bullet and the shell. As a result, decline in hardness and elastic modulus of the ceramic body can be reduced, and protecting performance against the flying object can be enhanced. In the above description, the term “at least a part of the remaining part” is used since a part of the second phase 3 may be present over the first phase 2 and the first phase 2.

The second phase 3 includes at least boron, silicon and carbon. For example, each of these elements is present alone, or the elements are present as silicide such as SiB₄ and SiB₆ formed by the combination of silicon and boron or silicon carbide. These compositions can be identified with an X-ray diffraction method. When the second phase 3 is a pillar phase or a needle-shaped phase which is present over the plurality of first phases 2, the movement of the phonon which is a heat conductive carrier is largely restricted. On the other hand, as in the embodiment, the second phases 3 are present in a granular state in the plurality of first phases 2, or are present in a granular state between the plurality of first phases 2, and thereby the movement of the phonon is hardly restricted. This exhibits the high thermal conductance of the silicon carbide crystal sufficiently, and suppresses the local temperature rise generated by the impact added from the flying objects such as the bullet and the shell. As a result, the decline in the hardness and elastic modulus of the ceramic body can be reduced, and the protecting performance against the flying object can be enhanced.

As shown in FIGS. 1 and 2, the thermal conductance of the ceramic body is also influenced by a distance d between the adjacent second phases 3. When the distance d is short, the movement of the phonon tends to be restricted. When the distance d is long, the movement of the phonon is hardly restricted.

From such a viewpoint, in the ceramic body of the embodiment, the distance d between the adjacent second phases 3 is preferably set to not less than 3 μm and not more than 5 μm. The movement of the phonon is further hardly restricted by setting the distance d to the above-mentioned range.

The cross section of the ceramic body is polished to be formed into a mirror finished surface (an arithmetic average height Ra is 0.03 μm or less). The mirror finished surface may be observed in a state where the second phase 3 is present in the first phase 2 or in a state where the second phase 3 is present between the plurality of first phases 2 at a magnification of 500 to 10,000 using a transmission electron microscope or a scanning electron microscope. Alternatively, the following method may be performed. Thin disk-shaped samples with a thickness of about 200 μm are cut from the ceramic body, and the thickness of the central part of each of the samples is reduced by a dimple grinder. A hole is then further formed in the central part by an ion milling method using argon (Ar) ions, and the surrounding surface thereof is observed at a magnification of 500 to 10,000 using the transmission electron microscope.

The second phase 3 may include Na, Mg, Fe, Al and Ca which are unavoidable impurities other than boron, silicon and carbon. The total content of these unavoidable impurities is suitably 1% by mass or less on the basis of 100% by mass of the ceramic body in view of maintaining the mechanical property thereof.

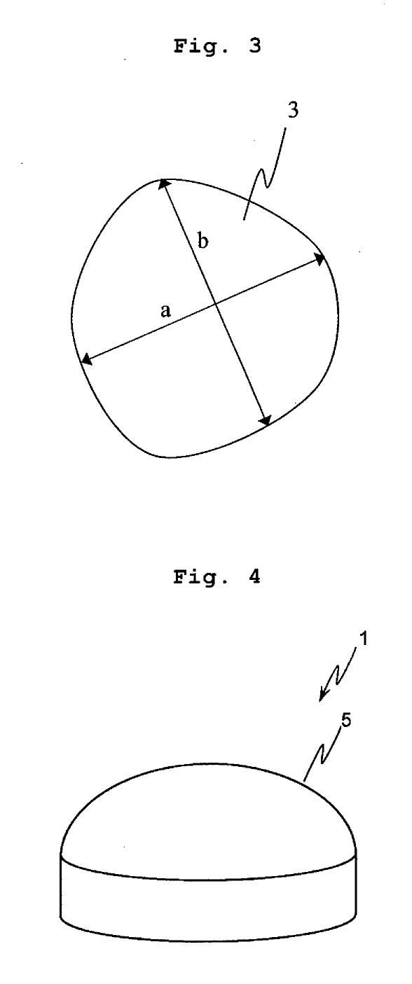

The thermal conductance and thermal shock resistance of the ceramic body tend to be influenced by the shape of the second phase 3, that is, the aspect ratio. As shown in FIG. 3, the aspect ratio of the second phase 3 is a ratio of a long axis b to a short axis a, the long axis b perpendicularly crossing with the short axis a. The movement of the phonon is hardly restricted so the ratio is smaller, and thereby both the thermal conductance and thermal shock resistance of the ceramic body are enhanced. Herein, the diameter of the circumscribed circle of the second phase 3 is defined as a long axis b. A straight line perpendicularly crossing with the long axis b at the middle point of the long axis b and passing through intersection points between the profile of the second phase 3 and the straight line is defined as the short axis a.

In the ceramic body of the embodiment, the second phase 3 is granular, and the aspect ratio thereof is suitably set to not less than 0.4 and not more than 2.5. Thereby, both the thermal conductance and thermal shock resistance of the ceramic body can be further enhanced.

The cross section of the ceramic body is polished to be formed into a mirror finished surface. The aspect ratio of the second phase 3 can be determined from an image with the magnification of 500 to 10,000, the image obtained by observing the mirror finished surface using the transmission electron microscope or the scanning electron microscope. Alternatively, the following method may be performed. Thin disk-shaped samples with a thickness of about 200 μm are cut from the ceramic body, and the thickness of the central part of each of the samples is reduced by a dimple grinder. A hole is then further formed in the central part by the ion milling method using argon (Ar) ions, and the surrounding surface thereof is observed at a magnification of 500 to 10,000 using the transmission electron microscope.

As described above, the second phase 3 includes at least boron, silicon and carbon. As described in detail later, in a method for manufacturing the ceramic body of the embodiment, silicon and carbon in the second phase 3 are obtained by forming and firing a material powder obtained by adding a boron carbide powder or the like to a silicon carbide powder and mixing the powders. Thereby, silicon and carbon are present as the second phase in the ceramic body. In particular, in the embodiment, boron included in the second phase executes an important action, and influences the mechanical property and thermal conductance of the ceramic body. Since silicon carbide crystal particles cannot be sufficiently bonded when the content of boron is too low, the mechanical property and the thermal conductance are reduced. On the other hand, when the content of boron is too high, the second phase having a high aspect ratio is deposited, thereby restricting the movement of the phonon to reduce the thermal conductance. In the ceramic body of the embodiment, the content of boron is suitably set to not less than 0.1% by mass and not more than 0.5% by mass on the basis of 100% by mass of the ceramic body. The ceramic body combining high mechanical property and thermal conductance can be obtained by setting the content to the above-mentioned range.

The content of boron can be measured using a fluorescent X-ray analysis method or an ICP (Inductively Coupled Plasma) emission spectroscopy.

Since the thermal conductivity of the ceramic body influences the thermal conductance and thermal shock resistance of the ceramic body, and both the thermal conductance and thermal shock resistance of the ceramic body are high when the thermal conductivity is high, the cracks are hardly generated even when the impact of the flying object is applied to the protective member.

From such a viewpoint, the thermal conductivity of the ceramic body of the embodiment is suitably 100 W/(m·K) or more. When the thermal conductivity is within the above-mentioned range, the cracks are hardly generated even when the impact of the flying object is applied to the ceramic body. Furthermore, the thermal conductivity is more suitably 140 W/(m·K) or more.

When the relative density of the ceramic body influences the mechanical property and thermal conductance of the ceramic body. When the relative density is high, the mechanical property and thermal conductance of the ceramic body are high.

From such a viewpoint, the relative density of the ceramic body of the embodiment is suitably 95% or more. Since the number of closed pores in the ceramic body is reduced and the thermal conductance is higher when the relative density is within the above-mentioned range, the local temperature rise is further suppressed.

As a result, the decline in the hardness and elastic modulus of the ceramic body can be reduced, and the penetration resistance against the flying object can be enhanced. Since the generation of microcracks is reduced, the protecting performance against the flying object can be enhanced.

Furthermore, the relative density is more suitably 98% or more. The relative density is calculated by the following formula using theoretical density and appearance density obtained according to JIS R 1634-1998. Since the ceramic body is a silicon carbide sintered body, the relative density may be calculated with the theoretical density set to 3.21 g/cm³.

Relative Density(%)=Appearance Density(g/cm³)/Theoretical Density(g/cm³)×100

The thermal shock resistance coefficient R′ specified by the following formulae (1) and (2) influences the penetration resistance of the ceramic body against the flying object. When the thermal shock resistance coefficient R′ is high, the penetration resistance of the ceramic body is high. Herein, the thermal shock resistance coefficient R is coefficient as the index of the thermal shock resistance in rapid cooling after heating. The thermal shock resistance coefficient R′ is coefficient as the index of the thermal shock resistance in slow cooling after heating.

R=S·(1−ν)/(E·α) (1)

S: three-point bending strength (Pa)
ν: Poisson ratio
E: Young's modulus (Pa)
α: thermal expansion coefficient at 40 to 400° C. (/K)

R′=R·k (2)

k: thermal conductivity (W/(m·K))

Suitably, the ceramic body of the embodiment has thermal shock resistance coefficient R′ of 32000 W/m or more, the thermal shock resistance coefficient R′ specified by the formulae (1) and (2). Since the thermal shock resistance is high when the thermal shock resistance coefficient R′ is within the above-mentioned range, the generation of the microcracks caused by thermal impact is reduced even when the impact from the flying object is applied to the ceramic body. Thereby, the penetration resistance against the flying object can be enhanced.

The three-point bending strength (S) may be measured according to JIS R 1601-1995; the Poisson ratio (ν) and the Young's modulus (E), JIS R 1602-1995; the thermal expansion coefficient (α) at 40 to 400° C., JIS R 1618-2002; and the thermal conductivity (k), JIS R 1611-1997. When the ceramic body is small and test pieces cannot be cut according to the dimensions of the test pieces defined by each of the JIS standards, the test pieces which can be cut in the possible range may be produced, and each of the physical property values may be measured. Bending test pieces according to JIS R 1601-1995 may be subjected to an oxidation treatment in an atmosphere of 900 to 1400° C. before a bending test to ease the influence of grinding flaws.

The protecting performance of the ceramic body of the embodiment is influenced by the shape of an impact receiving surface.

As shown in FIG. 4, the impact receiving surface 5 of the ceramic body of the embodiment is suitably a convex curved surface. Such a convex curved surface can greatly reduce a probability that the flight direction of the flying object coincides with the normal line of the surface of the ceramic body 1. As a result, since the flying object lands the impact receiving surface 5 of the ceramic body 1 while sliding on the impact receiving surface 5, the destructive energy of the flying object is absorbed or dissipated, and the protecting performance can be enhanced.

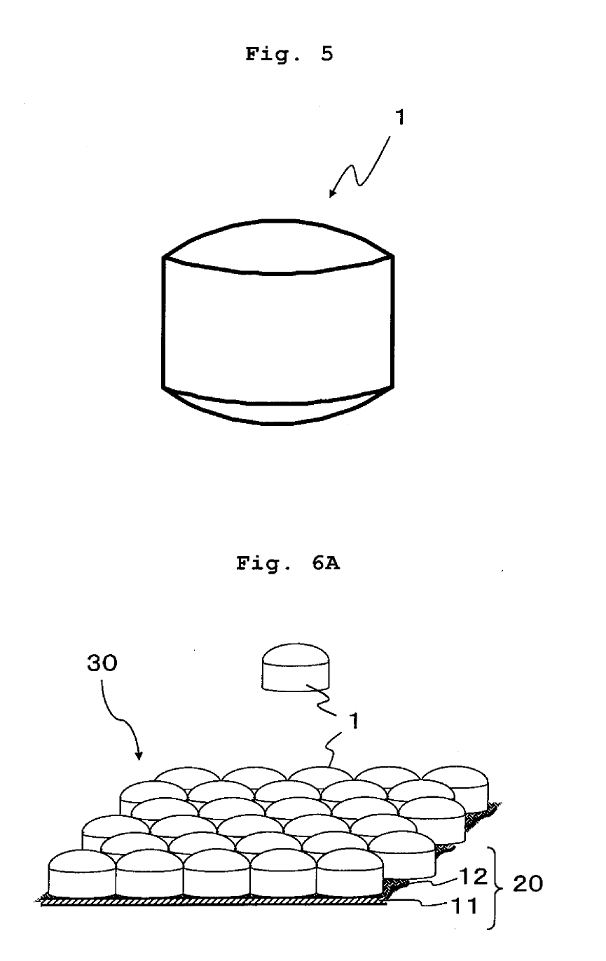

The ceramic body 1 is, for example, a cylindrical object, or as shown in FIG. 4, the ceramic body 1 is a spherical crown-shaped object having an upper surface having a curved surface formed in a convex shape toward the outer direction. Alternatively, as shown in FIG. 5, the upper and lower surfaces of the cylindrical object may be a curved surface formed in the convex shape toward the outer direction. For the size of the ceramic body 1, the outer diameter and the height are respectively set to 12 to 14 mm and 10 to 14 mm.

Thus, the ceramic body 1 has a shape surrounded by the upper and lower surfaces and a side peripheral surface along the peripheral edge parts thereof. The ceramic body 1 having at least one of the upper and lower surfaces having the curved surface formed in the convex shape toward the outer direction can be suitably used for protecting. In the case of the ceramic body 1 having only one of the upper and lower surfaces having the curved surface formed in the convex shape toward the outer direction, the surface having the convex curved surface may be set to the impact receiving surface.

As described above, the ceramic body of the embodiment has high protecting performance. Thereby, a product obtained by fixing the plurality of ceramic bodies on a suitable base is also suitably used for protective tools such as a bulletproof vest, a stab-proof vest, a stab-proof shield, a bag with a bulletproof function and a bulletproof helmet, and protective bodies such as a bulletproof plate.

Next, a method for manufacturing a ceramic body according to the embodiment will be described.

First, water, a dispersant, a boron carbide powder and sintering aids such as a phenol resin are added to a silicon carbide powder. The materials are mixed and ground in a ball mill to produce a slurry. A binder is added to, and mixed with the slurry, and the obtained mixture is then spray-dried to prepare granules including silicon carbide as a main component.

The content of boron to the ceramic body is influenced by the boron carbide powder to be added. The content of the boron carbide powder to the silicon carbide powder may be set to not less than 0.12% by mass and not more than 0.64% by mass in order to set the content of boron on the basis of 100% by mass of the ceramic body to not less than 0.1% by mass and not more than 0.5% by mass.

A predetermined forming die is filled with the obtained granules. A compact obtained by pressurizing the granules is heated in 10 to 40 hours in a nitrogen atmosphere if needed, and is held at 450 to 650° C. for 2 to 10 hours. The compact may be then naturally cooled to degrease the compact. For example, the obtained degreased body can be held and fired for 1 to 10 hours at a temperature of 1800 to 2200° C. in an inactive gas atmosphere to produce the ceramic body. Hot press may be performed with a pressurizing force set to 20 to 50 MPa at a temperature of 1800 to 2200° C. Particularly, the aspect ratio of a second phase 3 tends to be influenced by a firing temperature. When the firing temperature is set higher, the value of the aspect ratio is set larger. When the firing temperature is set lower, the value is set smaller. The firing temperature may be set to 1800 to 2100° C. in order to set the aspect ratio of the second phase 3 to not less than 0.4 and not more than 2.5.

The degreased body may be held at a temperature of 1900 to 2200° C. in an inactive gas atmosphere for 1 to 10 hours in order to set the thermal conductivity of the ceramic body to 100 W/(m·K) or more.

The degreased body may held at a temperature of 2000 to 2200° C. in the inactive gas atmosphere for 1 to 10 hours in order to set the relative density of the ceramic body to 95% or more.

A distance d between the adjacent second phases 3 tends to be influenced by firing time. When the firing time is set longer, the value of the distance d is set larger. When the firing time is set shorter, the value is set smaller. The firing time may be set to 4.5 to 5 hours in order to set the distance d between the adjacent second phases 3 to 3 μm or more.

The inactive gas is not particularly limited. Argon (Ar) is suitably used since argon is easily gotten and treated.

The above-mentioned manufacturing method can provide the ceramic body having high thermal conductance and thermal shock resistance and having high protecting performance.

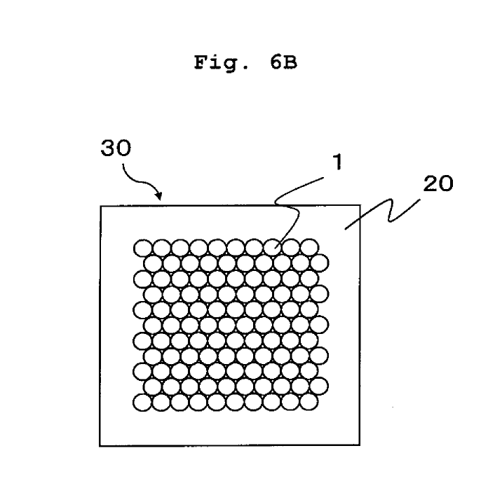

Next, an embodiment of a protective body will be described. As shown in FIGS. 6A and 6B, the above-mentioned plurality of ceramic bodies 1 can be arranged on the surface of a back plate 11 interposing a bonding member 12 made of a resin or the like, composed of a urethane-based adhesive, to produce the protective body. The back plate 11 constitutes, for example, a base 20 and is made of, for example, aluminum, steel and titanium or the like.

In this way, the flying object can be made to collide with the curved surface of the ceramic body 1 formed in a convex shape toward the outer direction. Thereby a probability that a contact angle between the flying direction of the flying object and the normal line of the surface of the ceramic body 1 is 90 degrees is greatly reduced. As a result, the flying object collides with the ceramic body 1 while sliding on the surface of the ceramic body 1, and thereby impact energy is eased, and the generation of cracks in the ceramic body 1 can be prevented. Therefore, a protective body 30, which has a structure capable of sufficiently suppressing the penetration of the flying objects such as a bullet and a shell, can sufficiently protect human bodies, vehicles, vessels, aircraft and buildings.

### EXAMPLES

Hereinafter, examples further embodying the embodiment will be described.

0.5% by mass of a boron carbide powder, purified water and a phenol aqueous solution were added to 100% by mass of a silicon carbide powder. The materials were mixed and ground in a ball mill to produce a slurry. This slurry was spray-dried to prepare granules including silicon carbide as a main component. The phenol aqueous solution was blended so that the content of a phenol component was 7% by mass on the basis of 100% by mass of the silicon carbide powder.

A predetermined forming die was filled with the obtained granules. The granules were formed with a pressurizing force of 98 MPa to produce a compact. This compact was then held under nitrogen flow at 550° C. for 3 hours to carbonize phenol, and thereby a degreased body was obtained.

The obtained degreased body was set in a graphite firing case, and was fired in an argon (Ar) atmosphere according to temperatures and holding times of Table 1 to obtain a ceramic body having a length of 100 mm, a width of 100 mm and a thickness of 6 mm. Sample No. 4 is a ceramic body obtained by setting the degreased body in a graphite mold and hot pressing the degreased body with a pressurizing force set to 30 MPa at a temperature of 2100° C. to compact the degreased body.

Herein, a three-point bending strength (S), a Poisson ratio (ν), a Young's modulus (E), a thermal expansion coefficient (α) at 40 to 400° C. and a thermal conductivity (k) were measured in order to calculate thermal shock resistance coefficients R′ of each of Sample Nos. 1 to 5 which is the ceramic body. The three-point bending strength (S) was obtained according to JIS R 1601-1995; the Poisson ratio (ν) and the Young's modulus (E), JIS R 1602-1995; the thermal expansion coefficient (α) at 40 to 400° C., JIS R 1618-2002; and the thermal conductivity (k), JIS R 1611-1997.

A urethane-based adhesive was applied onto aluminum plates (ADC12) having a length of 150 mm, a width of 150 mm and a thickness of 8 mm. Sample Nos. 1 to 5 were respectively bonded to the aluminum plates by curing the adhesive for 30 minutes at 70° C. while being pressurized at a pressure of 1 MPa to produce five protective plates as one kind of the protective body for each of Samples.

Bullets (308 Winchester FMJ) as one kind of the flying object were made to perpendicularly collide with the ceramic body side of each of the obtained protective plate at a speed of 840 m/s from a distance separated by 15 m. The number (hereinafter, referred to as “penetration blocking number”) of the bullets which did not penetrate the protective plates was measured. The protective plate in which the penetration blocking number was more was judged to be good.

TABLE 1

| | | | | | | Thermal shock | |
|---|---|---|---|---|---|---|---|
| | | Holding | Relative | Number of | Penetration | resistance | |
| Sample | Temperature | times | density | times of test | blocking | coefficient R′ | |
| No. | (° C.) | (hr) | (%) | performed | number | (W/m) | Notes |
| 1 | 1800 | 10 | 88.6 | 5 | 1 | 29750 | |
| 2 | 1900 | 5 | 93.2 | 5 | 3 | 32010 | |
| 3 | 2000 | 3 | 95.3 | 5 | 5 | 40070 | |
| 4 | 2100 | 3 | 99.5 | 5 | 5 | 61180 | Hot press performed with |
| | | | | | | | pressurizing force of 30 MPa |
| 5 | 2200 | 10 | 98.1 | 5 | 5 | 56080 | |

As can be seen from Table 1, all the protective plates have penetration blocking capability. It can be seen that the penetration blocking number of each of Sample Nos. 2 to 5 having thermal shock resistance coefficient R′ of 32000 W/m or more is more, and particularly, Sample Nos. 3 to 5 having thermal shock resistance coefficient R′ of 40000 W/m or more block all penetrations.

Thin disk-shaped samples having a thickness of about 200 μm were cut from the ceramic bodies used for these protective plates. The thickness of the central part of each of the samples was reduced by a dimple grinder. A hole was then further formed in the central part by an ion milling method using argon (Ar) ions. The surrounding surface thereof was observed with the magnification of 5,000 using a transmission electron microscope. When the components constituting the first phase and the second phase were identified, it was confirmed that the sample has the first phase including silicon carbide as a main component and the second phase including boron, silicon and carbon, wherein the whole of the second phase is present in the first phase, or the sample has the first phase including silicon carbide as the main component and the granular second phase including at least boron, silicon and carbon, wherein the second phase is present between the plurality of first phases.

It was confirmed that the aspect ratio of the second phase is 2.5 or less (excluding 0). When the content of boron was measured using an ICP (Inductively Coupled Plasma) emission spectroscopy, it was confirmed that the content of boron is not less than 0.1% by mass and not more than 0.5% by mass on the basis of 100% by mass of the ceramic body.

1. A protective member comprising a ceramic body having a plurality of first phases including silicon carbide as a main component, and a plurality of second phases having a composition different from that of the first phase and including at least boron, silicon and carbon.

2. The protective member according to claim 1, wherein a part of the plurality of second phases is present in the first phase as a whole.

3. The protective member according to claim 2, wherein at least a part of the remaining part of the plurality of second phases is present between the plurality of first phases.

4. The protective member according to claim 1, wherein an aspect ratio of the second phase is not less than 0.4 and not more than 2.5.

5. The protective member according to claim 1, wherein the ceramic body includes not less than 0.1% by mass and not more than 0.5% by mass of boron.

6. The protective member according to claim 1, wherein the ceramic body has a relative density of 95% or more.

7. The protective member according to claim 1, wherein the ceramic body has thermal shock resistance coefficient R′ of 32000 W/m or more, the coefficient R′ specified by the formula (1): R=S·(1−ν)/(E·α) wherein R is a thermal shock resistance coefficient; S is a three-point bending strength (Pa); ν is a Poisson ratio; E is a Young's modulus (Pa); and α is a thermal expansion coefficient at 40 to 400° C. (/K), and the formula (2): R′=R·k wherein k is a thermal conductivity (W/(m·K)).

8. The protective member according to claim 1, wherein the protective member has an impact receiving surface which is a convex curved surface.

9. A protective body comprising:
a base; and
at least one of the protective members according to claim 1 provided on the base.
